(19) United States
(12) Patent Application Publication
(10) Pub. No.: US 2007/0222636 A1
(43) Pub. Date: Sep. 27, 2007

(54) System and method for a networked utility meter

(75) Inventor: Ryuichi Iwamura, San Diego, CA (US)

Correspondence Address: FITCH EVEN TABIN & FLANNERY, 120 SOUTH LASALLE SUITE 1600, CHICAGO, IL, 60603, US

(73) Assignees: Sony Corporation, Shinagawa-ku (JP); Sony Electronics Inc., Park Ridge, NJ (US)

(21) Appl. No.: 11/373,560

(22) Filed: Mar. 9, 2006

(51) Int. Cl. G08C 19/16

(52) U.S. Cl. 340/870.01

(57) ABSTRACT

One embodiment can be characterized as a utility meter system comprising a utility meter connected to a local network through a local network communication interface, the utility meter enabled to monitor consumption of a utility received from a utility provider; and a second communication interface coupled to the utility meter through the local network, the second communication interface enabling data related to the consumption of the utility from the utility meter to be sent to the utility provider over a second communications network.

### BACKGROUND OF THE INVENTION

1. Field of the Invention

The present invention relates to utility meters. More specifically, the present invention relates to a utility meter with a network interface.

2. Discussion of the Related Art

Utility meters (such as electricity, gas and water meters) are used by utility providers (electric, gas and water companies, respectively) to monitor consumption of a utility, e.g., a utility good (e.g., gas, water and the like) or a utility service (e.g., electricity, telecommunications services and the like) by their customers. By way of example, electricity meters are used by electric supply companies to monitor and control the consumption of electric power. Generally, electricity meters are monitored by an employee of the electric company that travels from house to house and reads the electricity meter. This monitoring procedure is fairly expensive and time consuming.

One solution for remotely reading/monitoring an electricity meter is to send data to the electricity meter from the utility company over the large power grid and receive data back from the electricity meter over the power grid. However, some electricity companies are deterred from using such a system to remotely read electricity meters because it is not cost-effective. One drawback to using this type of system to read electricity meters is that typical pole or surface-mounted distribution transformers do not pass data signals. One solution to this problem would be to install a signal coupler to each transformer in order to pass data signals through the distribution transformer, but this would be costly.

Powerline communication (PLC) is a method of communication whereby power lines, which are part of a broadly-established infrastructure of power distribution in the United States and other countries, are used to provide data communication in addition to delivering power. In other words, PLC enables existing power lines, which already have been run throughout many homes and offices, to be used to carry data signals throughout the homes and offices.

Therefore, there is a need for a cost effective solution to remotely read a utility meter.

### SUMMARY OF THE INVENTION

The present embodiments generally provide a system and method for users and utility providers to monitor and control consumption of a utility.

One embodiment can be characterized as a utility meter system comprising a utility meter connected to a local network through a local network communication interface, the utility meter enabled to monitor consumption of a utility received from a utility provider; and a second communication interface coupled to the utility meter through the local network, the second communication interface enabling data related to the consumption of the utility from the utility meter to be sent to the utility provider over a second communications network. In some embodiments, the second communications network can be the Internet and the second communication interface can be a cable or digital subscriber line (DSL) modem. In some embodiments, a computer can be attached to the local network that is enabled to communicate with the utility meter and the utility provider in addition to one or more appliance(s) that may be attached to the local network.

A subsequent embodiment can be characterized as a method for monitoring consumption of a utility comprising monitoring consumption of a utility received from a utility provider at a utility meter, the utility meter having a local network communication interface for connection to a local network; and sending data related to the consumption of the utility, utilizing the local network communication interface, through the local network, over a second communication interface and through a second communications network to the utility provider.

Another embodiment can be characterized as a means for monitoring consumption of a utility comprising means for monitoring consumption of a utility received from a utility provider, the means for monitoring consumption of the utility having a local network communication interface for connection to a local network; and means for sending data related to the consumption of the utility, utilizing the local network communication interface, over a local network and a second communications network to the utility provider.

### BRIEF DESCRIPTION OF THE DRAWINGS

The above and other aspects, features and advantages of the present invention will be more apparent from the following more particular description thereof, presented in conjunction with the following drawings, wherein:

FIG. 1 is a diagram of a utility meter system in accordance with some embodiments of the present invention; and

FIG. 2 is a diagram of the internal block of an electricity meter in accordance with some embodiments of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions, sizing, and/or relative placement of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

The following description is not to be taken in a limiting sense, but is made merely for the purpose of describing the general principles of the invention. The scope of the invention should be determined with reference to the claims. The present embodiments address the problems described in the background while also addressing other additional problems as will be seen from the following detailed description.

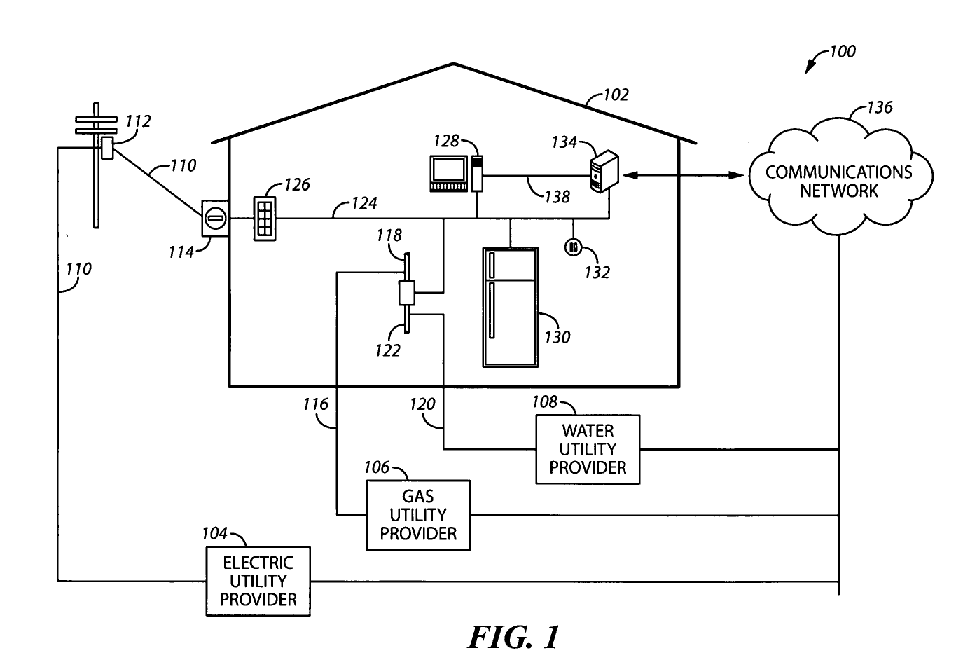

Referring to FIG. 1, a diagram of a utility meter system 100 in accordance with some embodiments of the present invention is shown. Shown is a customer unit 102 that is serviced by an electric utility provider 104, a gas utility provider 106 and a water utility provider 108. Also shown is a power line 110, a distribution transformer 112, an electricity meter 114, a gas line 116, a gas meter 118, a water line 120, a water meter 122, a local network 124, a switch board 126, a computer 128, a refrigerator 130, a power socket 132, a modem 134, a communications network 136 and a networking cable connection 138.

Each of the utility providers (i.e. the electric utility provider 104, the gas utility provider 106 and the water utility provider 108) is individually referred to as a utility provider, or collectively as utility providers, throughout this description. The utility providers may provide electricity, gas and/or water, respectively, to the customer unit 102. Electricity, gas and water are each individually referred to as a utility, or collectively as utilities, throughout this description. The customer unit 102 may, for example, be a home, a business or any other entity that consumes a utility.

The electric utility provider 104 provides electricity to the customer unit 102 via the power line 110. Electricity is supplied from the electric utility provider 104 over the power line 110 to the distribution transformer 112 and from the distribution transformer 112 over the power line 110 to the electricity meter 114. The electricity meter 114 measures electrical energy consumed by the customer unit 102.

The gas utility provider 106 provides gas to the customer unit 102 via the gas line 116. Gas is supplied from the gas utility provider 106 over the gas line 116 to the gas meter 118. The gas meter 118 measures gas consumed by the customer unit 102.

The water utility provider 108 provides water to the customer unit 102 via the water line 120. Water is supplied from the water utility provider 108 over the water line 120 to the water meter 122. The water meter 122 measures water consumed by the customer unit 102.

In some embodiments, one utility provider provides one or more utilities to a plurality of customer units. For example, one utility provider could provide any combination of one or more of electricity, gas and water to a plurality of customer units though a power line, a gas line and a water line, respectively. Additionally, in some embodiments, other utilities than specifically mentioned herein are delivered to a customer unit by a utility provider, such as, for example, any utility service or utility good where the utility provider monitors and/or controls the use and/or consumption of the utility service or utility good.

Still referring to FIG. 1, the local network 124 is shown at the customer unit 102. Connected to the local network 124 are the electricity meter 114, the gas meter 118, the water meter 122, the switchboard 126, the computer 128, the refrigerator 130, the power socket 132 and the modem 134. The local network 124, in one embodiment, is an internal power line network (i.e. a powerline communications (PLC) network). In the internal power line network, an internal power line connects the electricity meter 114 to the switchboard 126, and from the switchboard 126, the power line extends through the customer unit 102 and includes several connection points where a plurality of components (such as, for example, one or more appliance(s)) can connect to the internal power line. A PLC network conveniently uses existing power lines to establish communication between components attached to the power line, thereby reducing the amount of hardware a user needs to install. In various alternative embodiments, the local network 124 may be a telephone line network, Ethernet, Cable TV, coaxial cable network, Bluetooth, RF network, infrared network, or other physical network. In some embodiments, other components may be connected to the local network 124, for example, another appliance may be connected to the power socket 132 to join the local network 124. The modem 134, in the embodiment shown, is connected to the communications network 136.

The computer 128 is connected to the modem 134 via a networking cable connection 138. The networking cable connection 138 is, for example, an Ethernet cable. In some embodiments, the modem 134 is inside the computer 128. In some embodiments the computer 128 communicates with the modem 134 over the local network 124.

The modem 134 may be any one of a cable modem, DSL modem, ADSL modem, wireless modem or other type of broadband, narrowband or other modem. The modem 134 is enabled to send and receive data over the communications network 136. The modem 134 is one example of a communication interface to a communications network.

The communications network 136 may be any one of the Internet (i.e. a computer network), a telephone network, a wireless communications network, a satellite network, a RF network or other physical network. The communications network 136 connects (e.g. via the modem 134) the local network 124 with one or a plurality of the utility providers. An advantage of using the Internet to connect the local network 124 with the utility provider is that the Internet is widely available and thus, the utility providers and many users will not need to install any new hardware components to establish communications between the local network 124 and the utility provider.

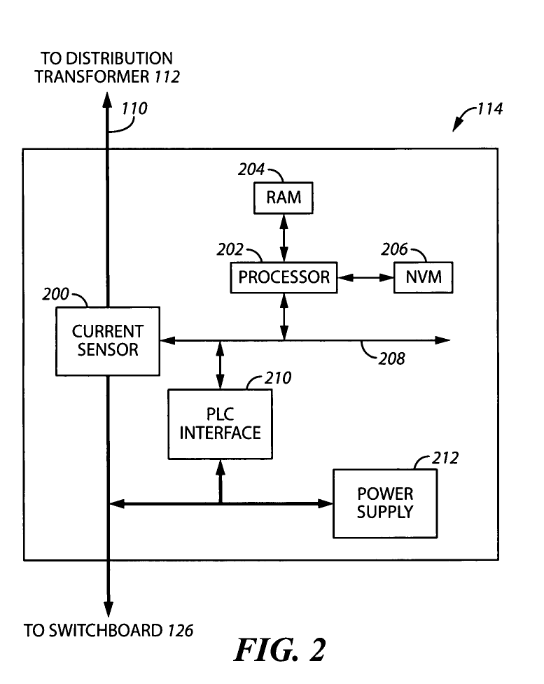

The utility meter system 100 enables utility providers and/or the customer unit 102 to monitor consumption of a utility. In one embodiment, the utility meter monitors utility consumption and sends data corresponding to the consumption over the local network 124 to the computer 128. By way of example, the local network 124 is a PLC network and, as described in detail below with reference to FIG. 2, the utility meter includes a PLC interface to enable the data from the utility meter to be sent over the PLC network. The computer 128 receives the data over the PLC network and then, through the modem 134, communicates over the Internet with the utility provider. The utility provider can also send data over the Internet to the computer 128 at the customer unit 102. In this manner, the utility provider and/or a user at the computer 128 can monitor utility consumption.

In an alternative embodiment, the utility meter monitors utility consumption and sends data corresponding to the consumption over the local network 124 directly to the modem 134. The utility meter having, for example, a PLC interface sends data over a PLC network. The data is sent directly from the utility meter to the modem 134 connected to the PLC network, and from the modem 134, the data is sent over the Internet. According to this embodiment, the utility provider can communicate directly with the utility meter over the modem 134. Alternatively, the connection between the utility meter and the modem 134 can be, for example, an Ethernet connection or a wireless connection.

In yet another embodiment, the utility meter includes an interface to a built-in modem for direct communication with the utility provider over the communications network 136. The utility meter monitors utility consumption and, utilizing a PLC interface, sends data corresponding to the consumption through the built-in modem to the utility provider. In this embodiment, the utility meter and modem form a local network that may or may not be connected to other devices.

In all of the above examples, the utility meter is connected to a local network 124 through a local network communication interface (e.g. a PLC connection, an Ethernet connection or connection to a built-in modem). A second communication interface (e.g. the modem 134) enables data related to the consumption of a utility to be sent to the utility provider over a second communications network (e.g. the Internet).

Referring to FIG. 2, a diagram of the internal block of the electricity meter 114 in accordance with some embodiments of the present invention is shown. The power line 110 carries electricity from the distribution transformer 112 to the electricity meter 114 and from the electricity meter 114 to the switchboard 126. Within the electricity meter 114 is a current sensor 200, a processor 202, a random access memory 204, a non-volatile memory 206, an internal bus 208, a PLC interface 210 and a power supply 212.

According to some embodiments, the processor 202 executes a software program stored in the non-volatile memory 206. The random access memory 204 is used as temporary storage and as a work area for the processor 202 as the processor 202 executes the software program. The processor 202 controls the PLC interface 210 and the current sensor 200 via the internal bus 208. The current sensor 200 may consist of a current transformer, an A/D converter (analog to digital converter) and a bus interface. The current sensor 200 collects data regarding the amount of current flowing though the electricity meter 114. The PLC interface 210 may be, for example, a HomePlug interface. The internal bus 208 may be, for example, an I2C bus (inter-integrated circuit bus). The power supply 212 converts AC 120 volts to, for example, DC 5 volts and supplies power to each block of the electricity meter 114. The processor 202 reads the output of the current sensor 200 and converts the output into (kilo) watt-hour units. The converted output is stored with time information in the non-volatile memory 206. In this manner the electricity meter 114 records data related to the consumption of electricity within the customer unit 102. One advantage of storing the data in the non-volatile memory 206 is that, in the event of a power break, the data is not lost. The data stored in the non-volatile memory 206 is sent through the PLC interface 210 to a destination (e.g. a computer). The PLC interface 210 is one example of a network communication interface. The data is sent using, for example, TCP/IP protocol.

In some embodiments, the data is sent from the utility meter over the local network 124 (e.g. a PLC network) to the computer 128. The data is then sent from the computer 128 to the utility provider through the modem 134 over the communications network 136 (e.g. the Internet).

In an alternative embodiment, the data is sent from the utility meter over the local network 124 directly to the modem 134. The data is then sent from the modem 134 to the utility provider over the communications network 136.

In yet another embodiment, the data is sent from the utility meter via a built-in modem directly to the utility provider.

The electricity meter 114 of FIG. 2 is illustrative of utility meters generally. That is, a PLC interface can be employed in, for example, a gas meter 118 and/or a water meter 122. A sensor employed in a gas meter 118 and/or water meter 122 can be configured to collect data regarding gas and/or water consumption, respectively. A processor within the gas meter 118 and/or a water meter 122 can be configured to convert sensor outputs into appropriate units for customers and utility providers. The PLC interface sends data corresponding to the consumption of the utility, as described above, to a computer 128 on the local network 124 or to the appropriate utility provider via the local network 124 and the communications network 136. Data can be sent using, for example, TCP/IP protocol.

Referring to FIGS. 1 and 2, in some embodiments, customer units register their utility meter(s) with the corresponding utility provider(s). A utility provider provides a software program to a user at the customer unit 102. The user can install the software program to the computer 128 and enter, for example, a customer unit or utility meter identification number and a password. In some embodiments, the computer 128, the electricity meter 114, the gas meter 118, the water meter 122, the switchboard 126, the refrigerator 130, the power socket 132 and the modem 134 are all connected to and can communicate with each other through the local network 124. Other appliances can also be connected to the local network 124. All communications between components on the local network 124 can be encrypted with a common key to prevent an outside user from tapping into the local network 124 or adding an illegal device to the local network 124.

After installing the software, the user can enter the identification number and the password into the computer 128. The computer 128 will then send the utility meter the common key encrypted, for example, with the password. The utility meter will decrypt the common key and join the local network 124. The utility meter can communicate with the corresponding utility provider via the modem 134 and the communications network 136 after the utility meter has joined the local network 124.

The utility provider is able to monitor a corresponding utility meter any time through the modem 134. Data transmission may be performed, for example, at a specified time, periodically or on demand. The utility provider also optionally remotely performs, for example, meter reconfiguration, tampering detection and meter diagnostics. Monitoring utility meter data can be beneficial in determining, for example, utility shortages or other issues that may arise.

In some embodiments, the computer 128 obtains utility meter data. The software installed on the computer 128 decrypts the data. The computer 128 can indicate to the user, in the case of an electric meter, for example, the current usage in kilowatt-hour and/or in dollars. In the case of water or gas meters, the computer 128 can obtain similar data regarding water or gas usage, respectively. Data regarding utility consumption or characteristics about a utility can be monitored in real time. Furthermore, the software can incorporate features that, for example, allow a user to pay a utility bill on-line via the Internet and/or allow a user to print a bill. In some embodiments, utility providers can communicate with a user at the computer 128 via the communications network, the modem 134 and the local network 124. Such a communication may be advantageous if, for example, the utility provider is trying to reduce overall consumption of a particular utility. In some embodiments, the computer 128 is on-line updated to provide information regarding new tariffs or changes in rates during specified hours.

In some embodiments, a PLC interface may be installed in one or more appliance(s). The computer 128 and/or a utility meter may communicate with and control an appliance if the appliance has a PLC interface. For example, in the case of an electricity meter 114, if an appliance is non-time sensitive, for example, a water pump, the computer 128 or the electricity meter 114 may control the appliance so that it automatically runs during off-peak times. The computer 128 or electricity meter 114 may also, for example, control a time-sensitive appliance, such as a refrigerator 130. Generally, the refrigerator 130 turns on/off its compressor based on the internal temperature sensor. However, if the refrigerator 130 has a PLC interface, the refrigerator 130 can obtain time-rate information from the computer 128 or the electricity meter 114. The refrigerator 130 can then turn on the compressor more frequently in the low rate time than in the high rate time. For example, during night (i.e. off-peak time), the refrigerator 130 can keep the temperature a little lower than the threshold the user set so that the compressor does not have to work frequently during daytime. Both the computer 128 and the electricity meter 114 may communicate directly with and adjust the refrigerator 130. In some embodiments, utility providers can also communicate over the communications network 136 and the local network 124 with appliances that have a PLC interface. As is discussed below, utility providers can remotely adjust the relevant appliance(s) to address a problem of, for example, leakage of a utility service or good.

In some embodiments, the utility meter(s) can detect leakage of a utility service or utility good. If unusual increases are detected (for example, current increase, gas leakage or water flood), then the corresponding utility meter can send a leakage warning to the computer 128 and to the utility provider. In some embodiments, additional sensing capability may be added to the utility meters. For example, in the case of the electricity meter 114, sensing capabilities could be added to detect information regarding a characteristic of the utility, such as AC voltage, line frequency, dropouts, surges, spikes or sags, that could affect a power grid of the electric utility provider 104. Such sensing capabilities are advantageous, for example, for the electric utility provider 104 to maintain the power grid. Data gathered by the electric meter can then be sent from the utility meter back to the utility provider over the communications network. Similar sensing capabilities can be added to gas and water meters to detect characteristics of the respective utility. In the case of leakage detection, utility providers, users (e.g. via the computer 128) and/or a utility meter may adjust the relevant appliance(s) with a PLC interface to address the leakage problem.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

What is claimed is:

1. A utility meter system comprising:
a utility meter connected to a local network through a local network communication interface, the utility meter enabled to monitor consumption of a utility received from a utility provider; and
a second communication interface coupled to the utility meter through the local network, the second communication interface enabling data related to the consumption of the utility from the utility meter to be sent to the utility provider over a second communications network.

2. The system of claim 1 wherein the utility is selected from the group consisting of electricity, gas and water, and wherein the utility meter is selected from the group consisting of an electricity meter, a gas meter and a water meter.

3. The system of claim 1 wherein the local network communication interface is a powerline communication (PLC) interface.

4. The system of claim 1 wherein the local network is at least partially an internal power line network.

5. The system of claim 1 wherein the second communication interface is selected from the group consisting of a cable modem and a digital subscriber line (DSL) modem.

6. The system of claim 1 wherein the second communications network is the Internet.

7. The system of claim 1 wherein the utility meter comprises a sensor, and wherein the utility provider is an electric utility provider, the electric utility provider having a power grid, wherein the sensor is enabled to sense a characteristic of the power grid.

8. The system of claim 7 wherein data corresponding to the characteristic of the power grid sensed by the sensor is sent from the utility meter to the utility provider.

9. The system of claim 1 further comprising a computer connected to the local network and at least one appliance connected to the local network, wherein the at least one appliance, the computer, the utility meter and the second communication interface are enabled to have communications with each other via the local network.

10. The system of claim 9 wherein the communications via the local network are encrypted.

11. The system of claim 9 wherein the computer and the utility provider are enabled to have communication with each other over the second communications network.

12. The system of claim 11 wherein the communication between the computer and the utility provider over the second communications network comprises paying a utility bill.

13. The system of claim 9 wherein the at least one appliance has a PLC interface.

14. The system of claim 13 wherein the utility provider is enabled to monitor and adjust a characteristic of the at least one appliance remotely over the second communications network and the local network.

15. The system of claim 13 wherein the utility meter is enabled to monitor and adjust a characteristic of the at least one appliance.

16. The system of claim 13 wherein the computer is enabled to monitor and adjust a characteristic of the at least one appliance.

17. The system of claim 13 wherein the utility meter comprises a sensor, the sensor enabled to sense a leakage of the utility at the at least one appliance.

18. A method for monitoring consumption of a utility comprising:
monitoring consumption of a utility received from a utility provider at a utility meter, the utility meter having a local network communication interface for connection to a local network; and
sending data related to the consumption of the utility, utilizing the local network communication interface, through the local network, over a second communication interface and through a second communications network to the utility provider.

19. The method of claim 18 wherein the utility is selected from the group consisting of electricity, gas and water, and wherein the utility meter is selected from the group consisting of an electricity meter, a gas meter and a water meter.

20. The method of claim 18 wherein the second communication interface is selected from the group consisting of a cable modem and a digital subscriber line (DSL) modem, and wherein the second communications network is the Internet.

21. The method of claim 18 further comprising communicating with the utility meter via a computer connected to the local network.

22. The method of claim 18 further comprising:
detecting a leakage of the utility; and
sending an alarm to at least one of a local computer or the utility provider.

23. The method of claim 18 further comprising:
monitoring a device connected to the local network; and
controlling the device from at least one of a local computer, the utility provider and the utility meter.

24. The method of claim 18 further comprising operating a device on the network during off-peak consumption hours.

25. The method of claim 18 further comprising displaying data related to the consumption of the utility on a local computer.

26. The method of claim 25 further comprising allowing a user to make a financial transaction related to the consumption of the utility on the local computer.

27. The method of claim 18 further sending communications from the utility provider to a local computer to communicate with a user.

28. The method of claim 18 further comprising sending data from the utility provider to perform at least one of utility meter reconfiguration, utility meter tamper detection and utility meter diagnostics.

29. A means for monitoring consumption of a utility comprising:
means for monitoring consumption of a utility received from a utility provider, the means for monitoring consumption of the utility having a local network communication interface for connection to a local network; and
means for sending data related to the consumption of the utility, utilizing the local network communication interface, over a local network and a second communications network to the utility provider.
